(19) United States
(12) Patent Application Publication
(10) Pub. No.: US 2005/0216293 A1
(43) Pub. Date: Sep. 29, 2005

(54) Method for a business to operate including the step of providing packets of sanitizer to customers and/or employees

(76) Inventor: Scott Martin Bushaw, La Habra, CA (US)

Correspondence Address: Scott Bushaw, 281 Stanford Street, La Habra, CA, 90631, US

(21) Appl. No.: 10/995,848

(22) Filed: Nov. 23, 2004

Related U.S. Application Data
(60) Provisional application No. 60/555,897, filed on Mar. 23, 2004.

(51) Int. Cl. G06F 17/60

(52) U.S. Cl. 705/1

(57) ABSTRACT

A method for a business to do business includes the step of providing sanitizer in single use packets to be used by a business's customers and/or employees without having to go to a central location to sanitize their hands, as well as allowing the business to not have to provide soap, water or other installed devices that may sanitize the hands in order to provide a way for the customers and/or employees of the business to sanitize the hands. The packets may be made available to customers and/or employees using any suitable process. The preferred sanitizer is one that has antibacterial or antimicrobial properties. The preferred packet can be made of any shape or size, be made out of any material and filled with any volume of sanitizer. The present invention allows for people to use the packets of sanitizer in situations they deem necessary.

This application claims the benefit of U.S. Provisional Application of Application No. 60/555,897, filed Mar. 23, 2004.

### BACKGROUND OF THE INVENTION

1. Technical Field

The present invention generally relates to any business that offers a product and/or service to customers and more particularly, relates methods for a business in the food service industry, transportation industry and the like to do business and provide a way for the customers and/or employees of the business to sanitize the hands without the need for installed devices that may sanitize the hands.

2. Background Art

Business all around the world offer a way for customers to get a product and/or service that they desire. The business is there to provide the customer with what they want and cater to their every need. All types of businesses operate in many different ways each specific to their own industry, but all having a common goal, which is to provide a product and/or service to their customers.

Hand sanitizer has been becoming a popular item for people to carry around with them as a way to sanitize their hands without the need for water and soap. Hand sanitizer is often, but not limited to, an alcohol based formula that has antibacterial and antimicrobial properties that sanitize the hands when it is applied to the hands. Many products come in bottles, but they are often too large to carry or are easily forgotten. Few companies make hand sanitizer in single use packets for consumers to use and carry with them as an alternative to large bottles. A prior art method as described in U.S. Pat. No. 6,228,375 addresses the problems associated with large bottles of sanitizer and adequately details a suitable single use packet that can be used in a method of offering hand sanitizer to customers and/or employees of a business. U.S. Pat. No. 6,228,375 does not specify how a business can make packets available to the customers and/or employees of a business, but rather describes packaging that may be suitable for such a packet to be used in my methods and claims. When relying on yourself to bring enough single use packets to use when you are away from water and soap, you may find you did not bring enough packets with you and find yourself in need of packets when you may deem necessary.

The food service industry is booming with numerous kinds of restaurants opening for business, such as sit down style restaurants, fast food restaurants, buffets and catering companies, which bring their food and services to different locations to satisfy their customer's needs. Restaurants and the like are in business to provide a service and product to their customers, and one of these services is cater to their customer's needs other than just serving food. This entails caring for the customers in inadvertent ways such as making sure the cook's have clean hands and the restaurant itself is a clean environment. Another way some restaurants have shown they care for their customers and their business is by providing adequate restrooms for customers to wash their hands, but a problem arises, with this not being adequate enough. As most parents know, children need to have clean hands, but it is often inconvenient to take children to use the restaurant's restrooms when the parents are of the opposite sex and it is often too dangerous to send a child alone to a restroom. Restrooms are not the cleanest part of the restaurant and after you have washed your hands, you still need to turn the faucet off, and get a paper towel from a dispenser, open the door and when you get back to your seat, you need to touch the chair and if it is before you ordered, you would need to touch the menu. All of the steps necessary to wash your hands in restrooms can transmit germs to people who use them. Many customers and employees only wash their hands when they have gone to the bathroom, but do not think about it before handling food. In buffet style restaurants, the customers share serving utensils, but not all of the customers have sanitary hands, which results in people eating with unsanitary hands, thus showing that without a convenient way for customers to sanitize their hands when they may deem necessary, the problems associated with soap and water will continue.

Prior art methods as described in detail in U.S. Pat. Application 20030191692 show the restaurant industry methods of adequate placement of hand sanitizer in dispensers in stationary locations for customers to use without going to the restroom. The application also describes the problems associated with sanitizing the hands with soap and water as well as the problems associated with restrooms. The methods and claims described in U.S. Pat. Application 20030191692 are often inconvenient as well. This method is often inconvenient making many people disregard the process entirely. This process forces the customers to get up from their chairs to use, but problems arise with this method as well, such as touching the chair when you get back to your seat, and any unforeseen problems that arise before your food comes, such as something dropping on the floor and touching the dirty object, thus making you get up and have to use the dispenser located in a stationary location of the restaurant. Stationary hand dispensers can also create lines to wait to use the dispenser, which can discourage a customer from wanting to use the dispensers at all. We now see that stationary hand sanitizing dispensers are often inconvenient and offer numerous problems.

Restaurants and the customers both suffer from unsanitary hands. The restaurant's employees can contract illnesses from customers who do not sanitize their hands properly and pass germs onto the employees or vise versa and have the employees pass germs onto the customers. Restaurants do not have a quick way for an employee to sanitize his or her hands after touching used napkins or plates of customers, which can result in the transmittal of germs. By using centrally located hand sanitizing dispensers, you are being told when to sanitize your hands and if you are not conveniently close to a hand sanitizing dispenser, or are too busy to go to a hand sanitizing dispenser, you may disregard sanitizing your hands completely, thus making a need for people to be able to use a product that they can use to sanitize their hands when they deem necessary and still be convenient.

In the healthcare industry, doctors, nurses and other healthcare officials take care of patients and do all they can to help them with physical ailments. The healthcare industry relates to hospitals, private practicing doctors, ambulance companies and the like. In hospitals, there are stationary mounted dispensers with hand sanitizer in the rooms of the patients for use by doctors and others of the medical staff. But one problem that the hospitals have is when there is a bed ridden patient; the patient cannot easily stand up and walk to a sink with soap and water or to the dispenser to sanitize their hands. A patient could very easily contract a disease through touch of a visitor or employee, which could adversely affect the patient and make their condition worse. Also, doctors, surgeons and nurses who work in the emergency rooms of hospitals must run from one patient to the next and make sure to adequately sanitize their hands in the process, but lack a quick and easy way to sanitize their hands without stopping what they are doing and sanitize their hands at a stationary hand sanitizer dispenser. Patients of many doctor's offices would feel safe if hand sanitizer was made available to them to help fight against any new contracted germs they could have picked up through contact of pens, door knobs, magazines and any other item in a doctors office where germs could be present. The patients, doctors, and nurses need a quick and convenient way to sanitize their hands when they feel necessary.

The government has service industries to help the citizens of their country and territories, examples of these service industries are the military, police force, firefighters, sheriffs and the like. The men and women who work in these industries need a quick convenient way to sanitize their hands after handling people that were just arrested and may contain germs that could be passed onto the workers or if someone who had just been rescued is in need of a quick way to sanitize their hands to stay safe. Also, while on a mission in the military, the troops still need to sanitize their hands safely and not risk their safety due to a possible contracted illness from an object that was touched and carried a germ on it. The problems associated with these government services not being able to be provided with a simple and effective way for their employees to sanitize their hands will continue if the problem is not solved.

When a business uses the methods and claims of my invention, the business will solve the problems associated with washing the hands with soap and water as well as many others. The business also solves the problem of having to provide soap and water for customers and/or employees of the business to sanitize their hands, but still being a service offered by the business. The problems associated with a business and adequate sinks will also be solved. By using the methods, the business does not have to install numerous sinks to be able to let a large number of people sanitize their hands at once or form long lines of people waiting to sanitize the hands. The business also eliminates the need to go to a central location of the business that has an area for customers and/or employees to sanitize the hands. The claims and methods of my invention would allow people to sanitize anywhere they want without having to go to a stationary area to sanitize the hands. For example, restaurants that offer drive thru service will be able to offer the customer a way to sanitize their hands without getting out of their car, much like the service the restaurant offers to the customers of being able to eat without getting out of their car.

The placement of places to sanitize the hands is also solved with the packets being able to be put onto surfaces in a non evasive way, such as construction of a sink. The problem of a business having to install expensive motion sensor devices which allow for hands free operation of sinks and the like can also be solved by using the methods and claims of my invention, by being able to offer the service of not having to touch a sink handle and the like.

Another problem solved by the methods and claims of my invention are a business that does not have a building or central location that cannot install sinks or devices that are convenient for employees and/or customers to sanitize the hands can solve this problem by using the methods and claims in my invention, which would allow a business to have their customers and/or employees be able to sanitize their hands no matter where they are. Such as with delivery drivers, ambulance drivers and the like, the business can offer them the same service as employees of the business that work at a central location where this service is provided.

By offering packets of sanitizer to customers and/or employees, the business does not have to install sinks in the first place, which solves the problem of a business that does not have restrooms or is unable to provide water and soap to customers and/or employees which is often inconvenient. By offering this service the business also does not have to pay for water bills associated with washing of the hands, as well as soap and paper towel bills associated with this same service.

### DISCLOSURE OF INVENTION

According to the preferred embodiments, a method for a business to provide a service and/or product to customers includes the step of providing sanitizer in single use packets for use by customers and/or employees of the business. The preferred sanitizer can be any sanitizer that is often used but not limited to sanitizing the hands. The preferred packets can be made of any size, shape, material and filled with any volume of sanitizer. The packets of sanitizer can be made available to the customers and/or employees of the business through using any suitable means. For example, the packets may be made available to the customers by placing them in an area of the business that the customers have access to in order for the customers to pick up themselves or any other suitable way.

The foregoing and other features and advantages of the invention will be apparent from the following more particular description of the preferred embodiments of the invention.

### BEST MODE FOR CARRYING OUT THE INVENTION

The methods of the preferred embodiments improve the health of our society by providing a simple and effective way for a business's customers and/or employees a way of sanitizing their hands when they deem necessary. In addition, the methods of the preferred embodiments provide a significant competitive advantage to a business that uses the methods in the preferred embodiments over a business that does not, by being able to advertise they have more sanitary conditions and that they care for their customers' health, which appeals to many people and would attract more customers to their business and keep repeating customers happy to return for more business.

An application for a business to use the methods and claims of my invention allows the business to not have to provide or install a sink, soap or other non single use device to customers and/or employees to be able to offer them a service of sanitizing the hands, while still being a service provided by the business. For example, a business that does not have access to running water or cannot install a device that can sanitize the hands can offer single use packets of sanitizer to customers and/or employees of the business and still allow the customers and/or employees to sanitize the hands.

Another application is also applied to the business's customers and/or employees allowing the customers and/or employees of the business to not have to go to a stationary location or device that may sanitize the hands, thus allowing them to sanitize the hands without the unnecessary step of going to a stationary location just to sanitize the hands.

Applying the application to a business also allows the business to save money on bathroom costs associated with sanitizing of the hands of customers and/or employees. Such as water bills, soap and paper towel costs that are used by people in order to sanitize the hands.

A business that uses the methods and claims of my invention gives them a competitive advantage over a business that does not offer the same service. The business that uses the methods and claims of my invention can keep their employees working with minimal time being spent walking back and forth to a stationary area to sanitize the hands, while the other business forces their customers and/or employees to go to a stationary location or device to sanitize the hands, which wastes time, thus creating a competitive advantage for the business that uses the methods and claims of my invention.

The methods and claims of my invention can also be applied to sanitizing the hands with soap and water, making my claims and methods be applied makes an improvement on sanitizing the hands without soap and water, thus creating a more efficient process of sanitizing the hands.

In recent years, hand sanitizer has become popular for people to clean their hands when they are unable to use soap and water. But, many people do not always remember to carry their own sanitizer due to lack of adequate places to put it or forgetfulness. Sanitizer has also become popular with healthcare workers and restaurants to use for their employees by using centrally mounted hand dispensers which have many drawbacks, as described in the Background section above.

While providing hand sanitizer to healthcare workers and in restaurants through stationary hand dispensers is known, it is unknown to provide a business's employees and/or customers a single use packets of hand sanitizer to sanitize their hands when they deem necessary, which could be used at the last moment before touching food or a patient. Even though hand sanitizer has been applied to the restaurant industry, nowhere does the prior art suggest that the customers and/or employees be given away by a business to use hand sanitizer in single use packets when they deem necessary.

Furthermore it is the placement of packets and steps used to make packets available to customers and/or employees as described in my claims and preferred embodiments to make available to the business's customers and/or employees. Nowhere does the prior art teach or suggest that a business use the placement of sanitizer packets and steps to supply customers and/or employees with sanitizer packets that a business can use as described in my preferred embodiments and claims. This is the subject matter of the preferred embodiments.

Referring now to any business that offers a product and/or service to customers, those skilled in the methods of working in or operating a business understand the steps involved in operating a business and can add the step of making hand sanitizer in single use packets available to customers and/or employees of the business to the methods of operating a business already in use by the business. The preferred business is one that is involved in the food service industry, transportation industry, and healthcare industry but, the method can be applied to any business that may provide a product and/or service to customers. The preferred embodiments expressly extend the use of my methods and claims to any suitable business.

Referring now to a business that provides a service and/or product to customers that can offer sanitizer in packets for use by customers and/or employees, the hand sanitizer is preferably a sanitizer that is not limited to, but often used to sanitize the hands, that has antimicrobial or antibacterial properties. The preferred embodiments expressly extend the use of any suitable sanitizer that may be applied to the hands and does not require soap or water.

Referring to a business that provides a product and/or service to customers that can supply sanitizer in packets to its customers and/or employees, a step that can be used for supplying packets to customers and or employees is placing the packets in any a suitable area of the business that customers have access to which would let the customer get the packets for themselves. For example, in a sit down style restaurant, where the customers sit down at tables to eat their food that the employees bring to them, the packets may be placed on the table next to the customer's silverware or in a suitable holder, such as a sugar packet holder.

Another example of suitable placement in a business that would allow the customers to get the packets for themselves is on a counter of the business where the customers pick up their food or product and can get the packets themselves. The packets may be put in suitable dispensers or any container that can adequately hold the packets of sanitizer. The dispensers or holders would allow the packets to be made available where the dispensers or holders can be placed, such as mounted on a wall. The preferred embodiments expressly extend the placement of packets of sanitizer to any suitable area of the business the customers have access to.

Referring to a business that provides a service and/or product to customers and can offer sanitizer in packets for use by customers and/or employees, the business can also allow the employees to have access to sanitizer packets by placing them in an area of the business only employees have access to, which would allow the employees to be able to use when they are in those areas of the business and not have to find packets in the customer accessible only areas of the business to use when they deem necessary.

Another way a business that provides a product and/or service to customers that can supply sanitizer in packets to its customers and/or employees can make packets of sanitizer available to customers and/or employees is by having employees give or hand the packets to customers of the business. For example in a drive through restaurant, the customer can place an order and the employee will give the customer their food while still in their car, making it possible to have the employee give the packets to the customer while giving them their product. The preferred embodiments expressly extend the way an employee can give packets of sanitizer to customers and when the employee can give the packet of sanitizer to the customer.

Another step a business that provides a product and/or service to customers that can supply sanitizer in packets to its customers and/or employees can make the packets available to their customers and/or employees is by making the packets available for the employees to carry around with them to be able to use when they deem necessary. The employees can carry the packets with them in holders, dispensers, in their pockets or in any other suitable way. This also allows the employees another convenient way to make available the packets to customers of the business, when the customer asks the employees for a packet they can hand them one and not have to go and get one. Another example of this is when emergency medical workers arrive at a scene to help victims, they might see that a victim needs to sanitize their hands, or the employee may feel they need to sanitize their hands, but are not close to a soap and water to do so. The preferred embodiments expressly extend the way an employee can use the packets to when they deem necessary.

Another way a business that provides a product and/or service to customers that can supply sanitizer in packets to its customers and/or employees can make the packets available to customers and/or employees is by placing the packets of sanitizer with other products. This allows the business to package a product and supply packets with sanitizer to customers at one time. An example of this is when a business makes pre-made food for camping and the like, the sanitizer can be attached to the product for the customer to carry the sanitizer with the product from the business and not have to rely on bringing sanitizer themselves. The preferred embodiments expressly extend the way a business can pack sanitizer packets with their products.

Another way a business that provides a product and/or service to customers that can supply sanitizer in packets to its customers and/or employees can make the packets available to customers and/or employees is by offering the packets in the private restrooms of the business for use by customers and/or employees of the business. The preferred embodiments expressly extend the placement of the packets of sanitizer in their private restrooms.

Referring to a business that provides a service and/or product to customers that can offer sanitizer in packets for use by customers and/or employees, the packets are preferably a durable material that can hold the sanitizer. The preferred embodiments expressly extend the use of any suitable material that can hold the sanitizer. The preferred embodiments expressly extend to the use of any suitable size of packet and any volume of sanitizer to be put into the packet. The preferred embodiments expressly extend the use of any suitable shape packet.

Referring to a business that provides a service and/or product to customers and can offer sanitizer in packets for use by customers and/or employees, the packets can be made available for the customers and/or employees in any suitable way. Preferably, the packets would be placed in parts of the business that customers have access to and can pick up themselves, for example in a restaurant, the packets can be placed on tables where customers would eat their food. The preferred embodiments expressly extend the way the packets can be made available to the customers and/or employees of the business to any suitable way.

A business that does business in accordance with the preferred embodiments can choose to use any number of methods or claims to apply with their own business. The method for a business to do business in accordance with the preferred embodiments can provide a significant competitive advantage in the market place.

A business that uses the claims and methods of my invention can advertise this, which gives the business an extra advantage over a business that does not offer the same service. The customers of the business will perceive the business that offers the packets as a cleaner business that cares for the health of its customers and employees. The business that offers single use packets of sanitizer will be perceived as a family friendly place to visit, because it offers parents a sanitary environment to bring their children, which will bring in new parents as customers and keep them returning to the business.

The business can give the customers of their business a new dining experience that will keep them talking, which is much like a word of mouth advertising campaign. The packets will also increase the business's customer's health, which will keep them healthy enough to return to the business more frequently.

While the invention has been shown in particular and described with reference to preferred embodiments thereof, it will be understood by those skilled in the art that various changes in form and details may be made wherein without departing from the spirit and scope of the invention. For example, while the specific examples presented herein refer to the food service industry and other particularly mentioned businesses, the methods for doing business disclosed herein could be used in virtually any type of business.

1. A method for a business to operate compromising the steps of:
(A) providing sanitizer in single use packets to customers and/or employees by placing at least one of the said packets in one or more areas of the business that customers of the said business have access to; and
(B) providing a service and/or product to customers of the said business.

2. The method of claim 1 further compromising the steps of:
(C) providing a way for customers and/or employees of the said business a way to sanitize the hands without having to install or provide soap, water or other non single use devices that may sanitize the hands; and
(D) providing a way for customers and/or employees of the business to sanitize the hands without having to go to a stationary device that may sanitize the hands.

3. The method of claim 1 wherein the sanitizer compromises a waterless, antibacterial or antimicrobial sanitizer that can be used to, but is not limited to sanitizing the hands.

4. A method for a business to operate compromising the steps of:
(A) providing sanitizer in single use packets to customers and/or employees of the said business by having at least one employee give any number of the said packets to any number of customers of the said business; and
(B) providing a service and/or product to customers of the said business.

5. The method of claim 4 further compromising the steps of:
(C) providing a way for customers and/or employees of the said business a way to sanitize the hands without having to install or provide soap, water or other non single use devices that may sanitize the hands; and
(D) providing a way for customers and/or employees of the business to sanitize the hands without having to go to a stationary device that may sanitize the hands.

6. The method of claim 4 wherein the sanitizer compromises a waterless, antibacterial or antimicrobial sanitizer that can be used to, but is not limited to sanitizing the hands.

7. A method for a business to operate compromising the steps of:
(A) providing sanitizer in single use packets to customers and/or employees of the said business by supplying at least one employee of the said business, with the said packets to carry and use in any way; and
(B) providing a service and/or product to customers of the said business.

8. The method of claim 7 further compromising the steps of:
(C) providing a way for customers and/or employees of the said business a way to sanitize the hands without having to install or provide soap, water or other non single use devices that may sanitize the hands; and
(D) providing a way for customers and/or employees of the business to sanitize the hands without having to go to a stationary device that may sanitize the hands.

9. The method of claim 7 wherein the sanitizer compromises a waterless, antibacterial or antimicrobial sanitizer that can be used to, but is not limited to sanitizing the hands.

10. A method for a business to operate compromising the steps of:
(A) providing sanitizer in single use packets to customers and/or employees of the said business by packaging the said packets with at least one product; and
(B) providing a service and/or product to customers of the said business.

11. The method of claim 10 further compromising the steps of:
(C) providing a way for customers and/or employees of the said business a way to sanitize the hands without having to install or provide soap, water or other non single use devices that may sanitize the hands; and
(D) providing a way for customers and/or employees of the business to sanitize the hands without having to go to a stationary device that may sanitize the hands.

12. The method of claim 10 wherein the sanitizer compromises a waterless, antibacterial or antimicrobial sanitizer that can be used to, but is not limited to sanitizing the hands.

13. A method for a business to operate compromising the steps of:
(A) providing sanitizer in single use packets to customers and/or employees of the said business by placing the said packets in at least one area of the business that only employees of the said business have access to; and
(B) providing a service and/or product to customers of the said business.

14. The method of claim 13 further compromising the steps of:
(C) providing a way for customers and/or employees of the said business a way to sanitize the hands without having to install or provide soap, water or other non single use devices that may sanitize the hands; and
(D) providing a way for customers and/or employees of the business to sanitize the hands without having to go to a stationary device that may sanitize the hands.

15. The method of claim 13 wherein the sanitizer compromises a waterless, antibacterial or antimicrobial sanitizer that can be used to, but is not limited to sanitizing the hands.
